(19) United States
(12) Patent Application Publication
(10) Pub. No.: US 2026/0142708 A1
(43) Pub. Date: May 21, 2026

(54) METHOD, APPARATUS AND SYSTEM FOR DATA TRANSMISSION

(71) Applicant: Huawei Technologies Co., Ltd., Shenzhen (CN)

(72) Inventors: Huazi Zhang, Hangzhou (CN); Jianglei Ma, Ottawa (CA); Wen Tong, Ottawa (CA)

(21) Appl. No.: 19/444,639

(22) Filed: Jan. 9, 2026

Related U.S. Application Data
(63) Continuation of application No. PCT/CN2024/096559, filed on May 31, 2024.
(60) Provisional application No. 63/513,043, filed on Jul. 11, 2023.

(51) Int. Cl. H04B 7/06; H04L 5/00

(52) U.S. Cl. CPC H04B 7/0632; H04L 5/0053

(57) ABSTRACT

An example method is provided. The method includes: transmitting information indicating a first set of resources for transmitting a first data transmission and a second set of resources for transmission a second data transmission, where the first set of resources and the second set of resources are at least partially overlapped; transmitting the first data transmission on the first set of resources; and transmitting the second data transmission on the second set of resources in response to determining that a condition is satisfied.

### CROSS-REFERENCE TO RELATED APPLICATIONS

This application is a continuation of International Patent Application PCT/CN2024/096559, filed on May 31, 2024, which claims the benefit of U.S. Provisional Patent Application No. 63/513,043, filed on Jul. 11, 2023. The entire contents of these disclosures are hereby incorporated by reference.

### TECHNICAL FIELD

The present disclosure generally relates to the field of wireless communication, and in particular, to a method, apparatus and system for data transmission, and a computer readable storage medium.

### BACKGROUND

With the current technology, there are several schemes for resource allocation. One scheme is pre-emption transmission. During pre-emption transmission, the incumbent Enhanced Mobile Broadband (eMBB) transmission may be punctured by an Ultra-reliable and Low Latency Communications (URLLC) packet. In such case, the successful decoding of the incumbent transmission may not be guaranteed. Another scheme is contention-based transmission. During contention-based transmission, the users may perform listen-before-talk, which means if an incumbent transmission is detected, the user needs to back off and wait for available resource. However, different transmission are likely to collide during contention-based transmission.

This background information is provided to reveal information believed by the applicant to be of possible relevance to the present disclosure. No admission is necessarily intended, nor should be construed, that any of the preceding information constitutes prior art against the present disclosure.

### SUMMARY

According to a first aspect, a method for data transmission is provided. According to a first aspect, a method for data transmission is provided. The method may be implemented by a transmitting apparatus, or modules in the transmitting apparatus (such as circuits, chips, or chip systems), or logic nodes, logic modules, or software that may perform all or some of the functions of the transmitting apparatus. In an example where the method is applied to a transmitting apparatus, the method comprises: transmitting information indicating a first set of resources and a second set of resources, the first set of resources for transmitting the first data transmission, and the second set of resources for transmitting the second data transmission, wherein the first set of resources and the second set of resources are at least partially overlapped; transmitting the first data transmission on the first set of resources; and transmitting the second data transmission on the second set of resources in a case where a condition is satisfied; wherein the condition includes at least one of: detecting a first signal indicating the second data transmission is to be transmitted on the second set of resources; detecting a second signal indicating the first data transmission is stopped; receiving a feedback indicating the first data is successfully decoded; a priority of the second data transmission is higher than a priority of the first data transmission; or a channel quality of a channel for transmitting the second data transmission is above a threshold.

In such case, conditions may be set for data transmission so that data transmission on resources which are overlapped may be conditionally scheduled. In this way, the transmitting apparatus may determine which data to be transmitted over the overlapped resources. The data transmission that is more important or urgent may be preferentially transmitted over the overlapped resources.

In some embodiments, the method further comprises: transmitting a first indication enabling receiving of the second data transmission on the second set of resources in the case where the condition is satisfied.

In this way, the transmitting apparatus may enable the receiving apparatus to adopt the method by transmitting the first indication.

In some embodiments, the method further comprises: transmitting a third signal indicating the second data transmission is to be transmitted on the second set of resources or the second data transmission is being transmitted on the second set of resources.

In this way, the transmitting apparatus may inform the receiving apparatus whether the second data transmission is to be transmitted or being transmitted on the second set of resources.

In some embodiments, the transmitting the third signal comprises: transmitting the third signal in the case where the condition is satisfied.

In some embodiments, the priority of the first data transmission and the priority of the second data transmission are each indicated by a respective priority index. Alternatively, the priority of the first data transmission and the priority of the second data transmission may be each indicated by a respective priority ID.

In some embodiments, the priority of the first data transmission is based on at least one of: a payload content of the first data transmission, a channel quality of a channel for transmitting the first data transmission, a transmission mode for transmitting the first data transmission, a bandwidth part for transmitting the first data transmission, an antenna configuration for transmitting the first data transmission, or a device capability for receiving the first data transmission.

In some embodiments, the priority of the second data transmission is based on at least one of: a payload content of the second data transmission, a channel quality of a channel for transmitting the second data transmission, a transmission mode for transmitting the second data transmission, a bandwidth part for transmitting the second data transmission, an antenna configuration for transmitting the second data transmission, or a device capability for receiving the second data transmission.

In some embodiments, the method further comprises: transmitting the third signal on a first N time domain resources of the second set of resources, where N is a positive integer.

In some embodiments, the method further comprises: sending a second indication indicating the resources for transmitting the third signal.

In this way, the receiving apparatus may know on which resources the third signal may be detected.

In some embodiments, the method further comprises: sending a third indication indicating a first time gap between a transmission time of the feedback and a start time at which the second data transmission is to be transmitted.

In this way, the receiving apparatus may know when to receive the second data transmission.

In some embodiments, the method further comprises: sending a fourth indication indicating a second time gap between a detection time of the feedback and a start time at which the second data transmission is to be transmitted.

In this way, the receiving apparatus may know when to receive the second data transmission.

In some embodiments, the third signal includes at least one of a reference signal or a synchronization signal.

In some embodiments, the reference signal includes at least one of: a demodulation reference signal (DMRS), a channel state information reference signal (CSI-RS), a sounding reference signal (SRS), or a phase tracking reference signal (PT-RS).

In some embodiments, the synchronization signal includes at least one of: a primary synchronization signal (PSS) or a secondary synchronization signal (SSS).

In some embodiments, the method further comprises: transmitting a fifth indication for indicating a priority index of the first data transmission, a priority index of the second data transmission, or the priority index of the first data transmission and the priority index of the second data transmission.

In such case, the receiving apparatus may know the priority of the first data transmission and the second data transmission. In this way, the receiving apparatus may know which data transmission will be transmitted over the overlapped resources.

According to a second aspect, a method for data transmission is provided. The method may be implemented by a receiving apparatus, or modules in the receiving apparatus (such as circuits, chips, or chip systems), or logic nodes, logic modules, or software that may perform all or some of the functions of the receiving apparatus. In an example where the method is applied to a receiving apparatus, the method comprises: receiving information indicating a first set of resources and a second set of resources, the first set of resources for receiving a first data transmission, the second set of resources for receiving a second data transmission, and the first set of resources and the second set of resources are at least partially overlapped; receiving the first data transmission on the first set of resources; and receiving the second data transmission on the second set of resources in a case where a condition is satisfied, wherein the condition includes at least one of: detecting a third signal indicating the second data transmission is to be transmitted on the second set of resources or the second data transmission is being transmitted on the second set of resources; the first data is successfully decoded; the first data transmission is stopped; a priority of the second data transmission is higher than a priority of the first data transmission; or a channel quality of a channel for transmitting the second data transmission is above a threshold.

In some embodiments, the method further comprises: receiving a first indication enabling receiving of the second data transmission on the second set of resources in the case where the condition is satisfied.

In some embodiments, the method further comprises: transmitting a first signal indicating the second data transmission is to be received on the second set of resources; or transmitting a second signal indicating the first data transmission is stopped; or transmitting a feedback indicating the first data is successfully decoded.

In some embodiments, the priority of the first data transmission and the priority of the second data transmission are each indicated by a respective priority index.

In some embodiments, the priority of the first data transmission is based on at least one of: payload content of the first data transmission, a channel quality of a channel for transmitting the first data transmission, transmission mode for transmitting the first data transmission, bandwidth part for transmitting the first data transmission, antenna configuration for transmitting the first data transmission, device capability for receiving the first data transmission.

In some embodiments, the priority of the second data transmission is based on at least one of: a payload content of the second data transmission, a channel quality of a channel for transmitting the second data transmission, a transmission mode for transmitting the second data transmission, a bandwidth part for transmitting the second data transmission, an antenna configuration for transmitting the second data transmission, or a device capability for receiving the second data transmission.

In some embodiments, the method further comprises: receiving the third signal on a first N time domain resources of the second set of resources, where N is a positive integer.

In some embodiments, the method further comprises: receiving a second indication indicating the resources for receiving the third signal.

In some embodiments, the method further comprises: receiving a third indication indicating a first time gap between a transmission time of the feedback and a start time at which the second data transmission is to be received.

In some embodiments, the third signal includes at least one of a reference signal or a synchronization signal.

In some embodiments, the reference signal includes at least one of: a demodulation reference signal (DMRS), a channel state information reference signal (CSI-RS), a sounding reference signal (SRS), or a phase tracking reference signal (PT-RS).

In some embodiments, the synchronization signal includes at least one of: a primary synchronization signal (PSS) or a secondary synchronization signal (SSS).

In some embodiments, the method further comprises: receiving a fifth indication for indicating a priority index of the first data transmission, a priority index of the second data transmission, or the priority index of the first data transmission and the priority index of the second data transmission.

According to a third aspect, a method for data transmission is provided. The method may be implemented by a receiving apparatus, or modules in the receiving apparatus (such as circuits, chips, or chip systems), or logic nodes, logic modules, or software that may perform all or some of the functions of the receiving apparatus. In an example where the method is applied to a receiving apparatus, the method comprises: receiving information indicating a second set of resources, the second set of resources for receiving a second data transmission, wherein the second set of resources and a first set of resources are at least partially overlapped, and the first set of resources for a first data transmission; and receiving the second data transmission on the second set of resources in a case where a condition is satisfied, wherein the condition includes at least one of: detecting a second signal indicating the first data transmission is stopped; detecting a third signal indicating the second data transmission is to be transmitted on the second set of resources or the second data transmission is being transmitted on the second set of resources; detecting a feedback indicating the first data transmission is successfully decoded; a priority of the second data transmission is higher than a priority of the first data transmission; or a channel quality of a channel for transmitting the second data transmission is above a threshold.

In some embodiments, the method further comprises: receiving a first indication enabling receiving of the second data transmission on the second set of resources in the case where the condition is satisfied.

In some embodiments, the method further comprises: transmitting a first signal indicating the second data transmission is to be received on the second set of resources.

In some embodiments, detecting a feedback includes detecting the feedback from a first device to a base station.

In some embodiments, the priority of the first data transmission and the priority of the second data transmission are each indicated by a respective priority index.

In some embodiments, the priority of the first data transmission is based on at least one of: payload content of the first data transmission, a channel quality of a channel for transmitting the first data transmission, transmission mode for transmitting the first data transmission, bandwidth part for transmitting the first data transmission, antenna configuration for transmitting the first data transmission, device capability for receiving the first data transmission.

In some embodiments, the priority of the second data transmission is based on at least one of: a payload content of the second data transmission, a channel quality of a channel for transmitting the second data transmission, a transmission mode for transmitting the second data transmission, a bandwidth part for transmitting the second data transmission, an antenna configuration for transmitting the second data transmission, or a device capability for receiving the second data transmission.

In some embodiments, the method further comprises: receiving the third signal on a first N time domain resources of the second set of resources, where N is a positive integer.

In some embodiments, the method further comprises: receiving a second indication indicating the resources for receiving the first signal.

In some embodiments, the method further comprises: receiving a fourth indication, the fourth indication for indicating a second time gap between a detection time of the feedback and a start time at which the second data transmission is to be received.

In some embodiments, the third signal includes at least one of a reference signal or a synchronization signal.

In some embodiments, the reference signal includes at least one of: a demodulation reference signal (DMRS), a channel state information reference signal (CSI-RS), a sounding reference signal (SRS), or a phase tracking reference signal (PT-RS).

In some embodiments, the synchronization signal includes at least one of: a primary synchronization signal (PSS) or a secondary synchronization signal (SSS).

In some embodiments, the method further comprises: receiving a fifth indication for indicating a priority index of the first data transmission, a priority index of the second data transmission, or the priority index of the first data transmission and the priority index of the second data transmission.

According to a fourth aspect, a method for data transmission is provided. The method may be implemented by a receiving apparatus, or modules in the receiving apparatus (such as circuits, chips, or chip systems), or logic nodes, logic modules, or software that may perform all or some of the functions of the receiving apparatus. In an example where the method is applied to a receiving apparatus, the method comprises: transmitting a scheduling information indicating a first set of resources and a second set of resources, the first set of resources for receiving the first data transmission, and the second set of resources for receiving the second data transmission, wherein the first set of resources and the second set of resources are at least partially overlapped; receiving the first data transmission on the first set of resources; and receiving the second data transmission on the second set of resources in a case where a condition is satisfied; the condition includes at least one of: detecting a first signal indicating the second data transmission is to be transmitted on the second set of resources; the first data transmission is stopped; a priority of the second data transmission is higher than a priority of the first data transmission; or a channel quality of a channel for receiving the second data transmission is above a threshold.

In some embodiments, the method further comprises: transmitting a first indication enabling transmitting of the second data transmission on the second set of resources in the case where the condition is satisfied.

In some embodiments, the method further comprises: transmitting a notification indicating stop of the first data transmission.

In some embodiments, the priority of the first data transmission and the priority of the second data transmission are each indicated by a respective priority index.

In some embodiments, the priority of the first data transmission is based on at least one of: payload content of the first data transmission, a channel quality of a channel for transmitting the first data transmission, transmission mode for transmitting the first data transmission, bandwidth part for transmitting the first data transmission, antenna configuration for transmitting the first data transmission, device capability for transmitting the first data transmission.

In some embodiments, the priority of the second data transmission is based on at least one of: a payload content of the second data transmission, a channel quality of a channel for transmitting the second data transmission, a transmission mode for transmitting the second data transmission, a bandwidth part for transmitting the second data transmission, an antenna configuration for transmitting the second data transmission, or a device capability for transmitting the second data transmission.

In some embodiments, the method further comprises: transmitting a second indication indicating a first time gap between a receiving time of the notification and a start time at which the second data transmission is to be received.

In some embodiments, the method further comprises: transmitting a third indication indicating a second time gap between a detection time of the notification and a start time at which the second data transmission is to be received.

In some embodiments, the method further comprises: receiving a fourth indication for indicating a priority index of the first data transmission, a priority index of the second data transmission, or the priority index of the first data transmission and the priority index of the second data transmission.

According to a fifth aspect, a method for data transmission is provided. According to a first aspect, a method for data transmission is provided. The method may be implemented by a transmitting apparatus, or modules in the transmitting apparatus (such as circuits, chips, or chip systems), or logic nodes, logic modules, or software that may perform all or some of the functions of the transmitting apparatus. In an example where the method is applied to a transmitting apparatus, the method comprises: receiving information indicating a first set of resources and a second set of resources, the first set of resources for transmitting a first data transmission, the second set of resources for transmitting a second data transmission, and the first set of resources and the second set of resources are at least partially overlapped; transmitting a first data transmission on the first set of resources; and transmitting a second data transmission on the second set of resources in a case where a condition is satisfied, wherein the condition includes at least one of: receiving a notification indicating the stop of the first data transmission; the first data transmission is stopped; a priority of the second data transmission is higher than a priority of the first data transmission; or a channel quality of a channel for transmitting the second data transmission is above a threshold.

In some embodiments, the method further comprises: receiving a first indication enabling the transmitting of the second data transmission on the second set of resources in the case where the condition is satisfied.

In some embodiments, the priority of the first data transmission and the priority of the second data transmission are each indicated by a respective priority index.

In some embodiments, the priority of the first data transmission is based on at least one of: payload content of the first data transmission, a channel quality of a channel for transmitting the first data transmission, transmission mode for transmitting the first data transmission, bandwidth part for transmitting the first data transmission, antenna configuration for transmitting the first data transmission, device capability for transmitting the first data transmission.

In some embodiments, the priority of the second data transmission is based on at least one of: a payload content of the second data transmission, a channel quality of a channel for transmitting the second data transmission, a transmission mode for transmitting the second data transmission, a bandwidth part for transmitting the second data transmission, an antenna configuration for transmitting the second data transmission, or a device capability for transmitting the second data transmission.

In some embodiments, the method further comprises: receiving a second indication indicating a first time gap between a receiving time of the notification and a start time at which the second data transmission is to be transmitted.

In some embodiments, the method further comprises: transmitting a fourth indication for indicating a priority index of the first data transmission, a priority index of the second data transmission, or the priority index of the first data transmission and the priority index of the second data transmission.

According to a sixth aspect, a method for data transmission is provided. According to a first aspect, a method for data transmission is provided. The method may be implemented by a transmitting apparatus, or modules in the transmitting apparatus (such as circuits, chips, or chip systems), or logic nodes, logic modules, or software that may perform all or some of the functions of the transmitting apparatus. In an example where the method is applied to a transmitting apparatus, the method comprises: receiving information indicating a second set of resources, the second set of resources for transmitting a second data transmission, wherein the second set of resources and a first set of resources are at least partially overlapped; the first set of resources for a first device transmitting a first data transmission; and transmitting a second data transmission on the second set of resources in a case where a condition is satisfied, wherein the condition includes at least one of: detecting absence of the first data transmission; detecting a notification indicating the stop of the first data transmission; a priority of the second data transmission is higher than a priority of the first data transmission; or a channel quality of a channel for transmitting the second data transmission is above a threshold.

In some embodiments, the method further comprises: receiving a first indication enabling the transmitting of the second data transmission on the second set of resources in the case where the condition is satisfied.

In some embodiments, the priority of the first data transmission and the priority of the second data transmission are each indicated by a respective priority index.

In some embodiments, the priority of the first data transmission is based on at least one of: payload content of the first data transmission, a channel quality of a channel for transmitting the first data transmission, transmission mode for transmitting the first data transmission, bandwidth part for transmitting the first data transmission, antenna configuration for transmitting the first data transmission, device capability for transmitting the first data transmission.

In some embodiments, the priority of the second data transmission is based on at least one of: a payload content of the second data transmission, a channel quality of a channel for transmitting the second data transmission, a transmission mode for transmitting the second data transmission, a bandwidth part for transmitting the second data transmission, an antenna configuration for transmitting the second data transmission, or a device capability for transmitting the second data transmission.

In some embodiments, the method further comprises: receiving a third indication indicating a second time gap between a detection time of the notification and a start time at which the second data transmission is to be transmitted.

In some embodiments, the method further comprises: transmitting a fourth indication for indicating a priority index of the second data transmission.

According to a seventh aspect, an apparatus is provided. The apparatus comprises a processor configured to cause the apparatus to perform the method for data transmission in any one of the first aspect to the sixth aspect, or any possible implementation of any one of the first aspect to the sixth aspect.

According to an eighth aspect, a computer-readable medium is provided. The computer-readable storage medium has stored thereon computer program instructions that, when executed by a processing circuit of a computer, cause the computer to implement the method for data transmission in any one of the first aspect to the sixth aspect, or any possible implementation of any one of the first aspect to the sixth aspect.

According to a ninth aspect, a computer program product is provided. The computer program product has instructions that, when executed by a computer, cause the computer to implement the method for data transmission in any one of the first aspect to the sixth aspect, or any possible implementation of any one of the first aspect to the sixth aspect.

According to a tenth aspect, a system is provided. The system comprises: a first apparatus for implementing the method for data transmission in the first aspect or any possible implementation of the first aspect; and a second apparatus for implementing the method for data transmission in the second aspect or the third aspect or any possible implementation of the second aspect or the third aspect.

According to an eleventh aspect, a system is provided. The system comprises: a first apparatus for implementing the method for data transmission in the fourth aspect or any possible implementation of the fourth aspect; and a second apparatus for implementing the method for data transmission in the fifth aspect or the sixth aspect or any possible implementation of the fifth aspect or the sixth aspect.

The advantages brought by any design from the second to eleventh aspects can be referred to the first aspect or the different designs of the first aspect, which will not be detailed here.

On the basis of the implementations provided in the above aspects, the present disclosure is able to provide more implementations by further combination.

### BRIEF DESCRIPTION OF THE DRAWINGS

FIG. 1A is a schematic diagram illustrating an exemplary pre-emption transmission in the related art;

FIG. 1B is a schematic diagram illustrating an exemplary contention-based transmission in the related art;

FIG. 2 shows a communication system in which embodiments of the present disclosure may be implemented;

FIG. 3 shows another communication system in which embodiments of the present disclosure may be implemented;

FIG. 4 shows an apparatus that wirelessly communicates with at least one apparatus in a communication system in accordance with some embodiments of the present disclosure;

FIG. 5 shows a block diagram of an electronic device or apparatus in accordance with some embodiments of the present disclosure;

FIG. 6 is a schematic diagram illustrating resources allocated for different data transmissions in accordance with some embodiments of the present disclosure;

FIG. 7 shows a signaling chart in accordance with some embodiments of the present disclosure;

FIG. 8 is another schematic diagram illustrating resources allocated for different data transmissions in accordance with some embodiments of the present disclosure;

FIGS. 9A-9D are schematic diagrams illustrating method for data transmission in accordance with some embodiments of the present disclosure;

FIGS. 10A and 10B are yet another schematic diagrams illustrating resources allocated for different data transmissions in accordance with some embodiments of the present disclosure;

FIGS. 11A-11C are another schematic diagrams illustrating method for data transmission in accordance with some embodiments of the present disclosure;

FIG. 12 is another schematic diagram illustrating method for data transmission in accordance with some embodiments of the present disclosure; and

FIG. 13 shows another signaling chart in accordance with some embodiments of the present disclosure.

### DETAILED DESCRIPTION OF ILLUSTRATIVE EMBODIMENTS

The With the current technology, there are several schemes for resource allocation and data transmission. One scheme is pre-emption transmission, and another scheme is contention-based transmission.

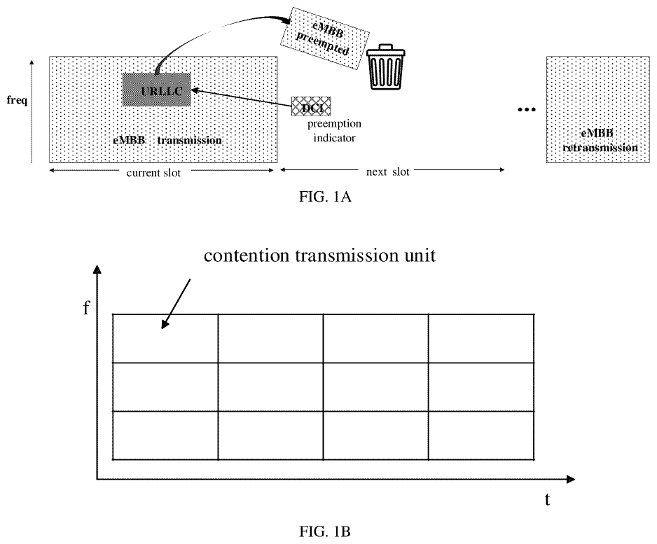

Referring to FIG. 1A, in 5G NR, URLLC is supported partly by pre-emption, for example, a URLLC packet can preempt an ongoing eMBB transmission.

In a case where pre-emption occurs in one slot, a pre-emption indicator (e.g., DCI Format 2_1) will be transmitted over the control channel at the beginning of the next slot to indicate the preempted resource position such that the receiver will know the resource for receiving the URLLC packet. In addition, the receiver will flush the preempted part of soft Log Likelihood Ratios (LLRs), as if the ongoing eMBB transmission is punctured. However, puncturing in some bit positions (e.g., some systematic bit positions) can be catastrophic. Very likely, the impaired ongoing eMBB transmission will require an HARQ retransmission. When pre-emption occurs, the successful decoding of incumbent transmission is not guaranteed. In addition, in pre-emption scenario, newly scheduled transmission (e.g., the URLLC packet) is scheduled after transmission, that is, the allocated resource for the newly scheduled transmission is indicated after transmission.

Referring to FIG. 1B, in contention-based transmission scenarios, a set of resources may be allocated to multiple users (e.g., UE1, UE2, UE3, and UE4). The users may perform listen-before-talk, which means if an incumbent transmission for another user (e.g., UE2) is detected by a user (e.g., UE3), the user (i.e., UE3) needs to back off and wait for available resource. The channel access rule is first-come-first-serve, which means no priority is inherently associated to any transmission.

To solve the above problems, the present disclosure provides a method for data transmission, which includes multiple solutions.

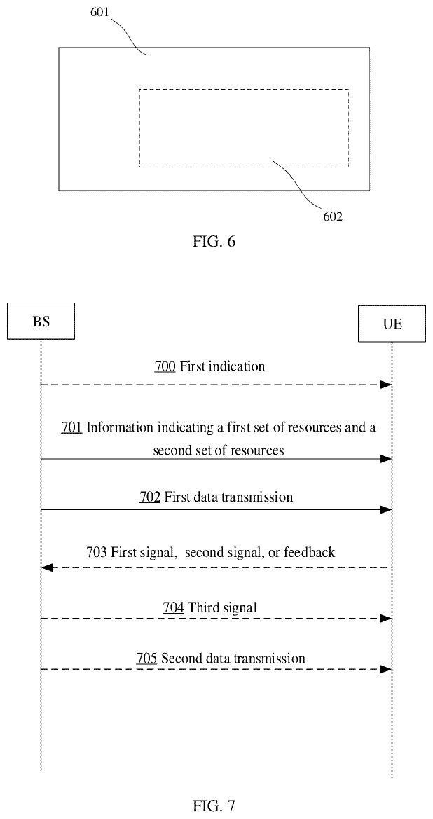

Referring to FIG. 6, resource 601 (the rectangle shown in solid line) is allocated for a primary transmission, and resource 602 (the rectangle shown in dashed line) is allocated for both primary and secondary transmissions. Moreover, resource 602 is conditionally allocated for secondary transmission, given that primary transmission is not transmitted here.

The solutions described in the disclosure is applicable to a wide range of communication networks, such as a next or future generation (e.g., 5G+ or later) network, or a legacy (e.g., 5G, 4G, 3G or 2G) network. The solutions may also be implemented in WiFi, NTN, cloud and edge computing service, sensing services, or distributed or self-organized networks. In an example, the solutions may be applied to automated manufacturing systems in smart factories. In another example, it may be applied to other intelligent vertical scenarios such as ports, delivery systems and medical systems.

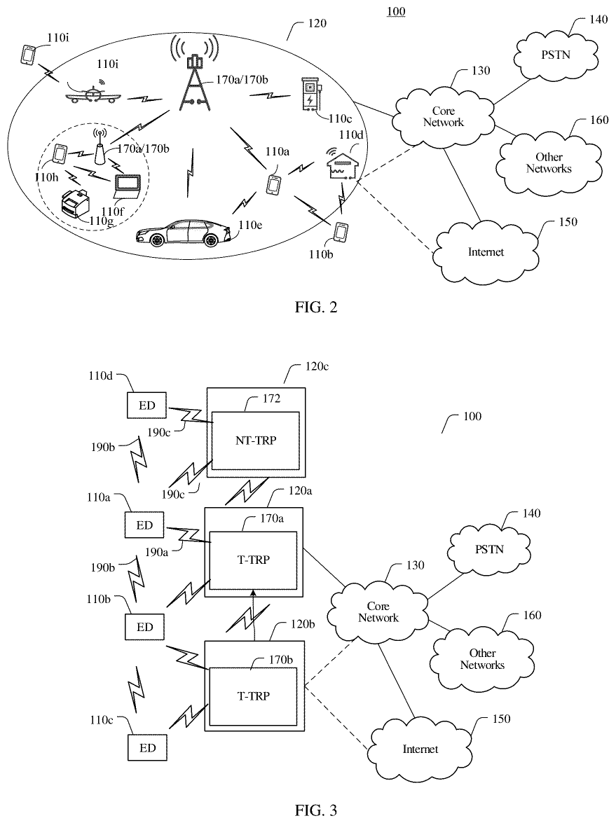

Referring to FIG. 2, as an illustrative example without limitation, a simplified schematic illustration of a communication system according to some embodiments of this disclosure is provided. The communication system 100 comprises a radio access network 120. The radio access network 120 may be a next or future generation radio access network, or a legacy (e.g., 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

FIG. 3 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANS 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

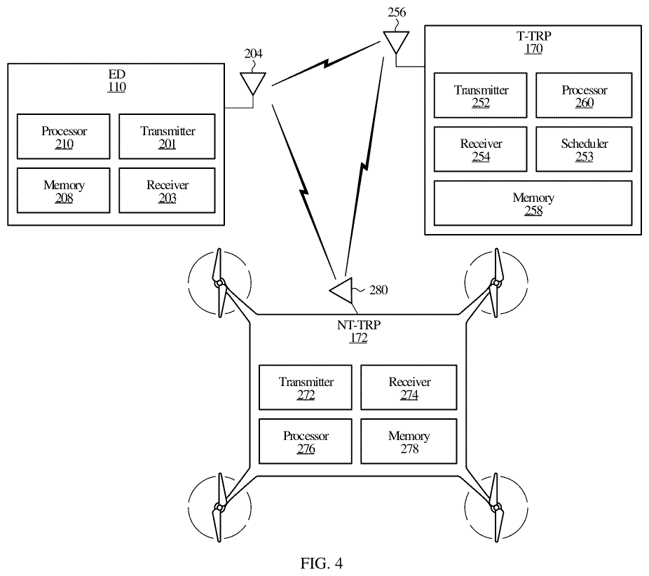

FIG. 4 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g., as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 2). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g., beam angle information (BAI), received from T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g., in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g., communication module, modem, or chip) in the forgoing devices.

In different systems, the CU (or the CU-CP and the CU-UP), the DU, or the RU may also have different names, but a person skilled in the art may understand meanings thereof. For example, in an ORAN system, a CU may also be referred to as an open CU (O-CU), a DU may also be referred to as an open DU (O-DU), and a CU-CP may also be referred to as an open CU-CP (O-CU-CP). The CU-UP may also be referred to as an open CU-UP (O-CU-UP), and the RU may also be referred to as an open RU (O-RU).

Any one of the CU (or the CU-CP, the CU-UP), the DU, and the RU may be implemented by using a software module, a hardware module, or a combination of a software module and a hardware module.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g., through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates the indication of beam direction, e.g., BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g., a physical downlink control channel (PDCCH), and static or semi-static higher layer signaling may be included in a packet transmitted in a data channel, e.g., in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g., in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g., BAI) received from T-TRP 170. In some embodiments, the processor 276 may generate signaling, e.g., to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g., in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

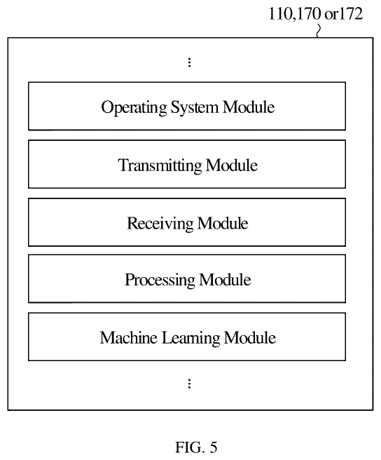

One or more steps of the embodiment methods provided herein may be performed by corresponding units or modules, according to FIG. 5. FIG. 5 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The followings are some examples for the above components:

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

A frame structure is a feature of the wireless communication physical layer that defines a time domain signal transmission structure, e.g., to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g., for use in a future network or later. In a flexible frame structure, a symbol block may be defined as the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters in some embodiments of a flexible frame structure include:

(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.

(2) Subframe duration: A subframe might or might not be defined in the flexible frame structure, depending upon the implementation. For example, a frame may be defined to include slots, but no subframes. In frames in which a subframe is defined, e.g., for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

(3) Slot configuration: A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.

(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

(5) Flexible transmission duration of basic transmission unit: The basic transmission unit may be a symbol block (alternatively called a symbol), which in general includes a redundancy portion (referred to as the CP) and an information (e.g., data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: channel condition (e.g., multi-path delay, Doppler); and/or latency requirement; and/or available time duration. As another example, a symbol block length may be adjusted to fit an available time duration in the frame.

(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g., a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g., base station) dynamically, e.g., in physical layer control signaling such as DCI, or semi-statically, e.g., in radio resource control (RRC) signaling or in the medium access control (MAC) layer, or be predefined based on the application scenario; or be determined by the UE as a function of other parameters that are known by the UE, or may be fixed, e.g., by a standard.

In current networks, frame timing and synchronization is established based on synchronization signals, such as a primary synchronization signal (PSS) and a secondary synchronization signal (SSS). Notably, known frame timing and synchronization strategies involve adding a timestamp, e.g., (xxo:yyo:zz), to a frame boundary, where xxo, yyo, zz in the timestamp may represent a time format such as hour, minute, and second, respectively.

It is anticipated that diverse applications and use cases in future networks may involve usage of different periods of frames, slots and symbols to satisfy the different requirements, functionalities and Quality of Service (QoS) types. It follows that usage of different periods of frames to satisfy these applications may present challenges for frame timing alignment among diverse frame structures. Consider, for example, frame timing alignment for a TDD configuration in neighboring carrier frequency bands or among sub-bands (or bandwidth parts) of one channel/carrier bandwidth.

The present disclosure relates, generally, to mobile, wireless communication and, in particular embodiments, to a frame timing alignment/realignment, where the frame timing alignment/realignment may comprise a timing alignment/realignment in terms of a boundary of a symbol, a slot or a sub-frame within a frame; or a frame (thus the frame timing alignment/realignment here is more general, not limiting to the cases where a timing alignment/realignment is from a frame boundary only). Also, in this application, relative timing to a frame or frame boundary should be interpreted in a more general sense, i.e., the frame boundary means a timing point of a frame element with the frame such as (starting or ending of) a symbol, a slot or subframe within a frame, or a frame. In the following, the phrases “(frame) timing alignment or timing realignment” and “relative timing to a frame boundary” are used in more general sense described in above.

In overview, aspects of the present application relate to a network device, such as a base station 170, referenced hereinafter as a TRP 170, transmitting signaling that carries a timing realignment indication message. The timing realignment indication message includes information allowing a receiving UE 110 (an example of ED 110) to determine a timing reference point. On the basis of the timing reference point, transmission of frames, by the UE 110, may be aligned. In some aspects of the present application, the frames that become aligned are in different sub-bands of one carrier frequency band. In other aspects of the present application, the frames that become aligned are found in neighboring carrier frequency bands.

On the TRP 170 side, aspects of the present application relate to use of one or more types of signaling to indicate the timing realignment (or/and timing correction) message. Two example types of signaling are provided here to show the schemes. The first example type of signaling may be referenced as cell-specific signaling, examples of which include group common signaling and broadcast signaling. The second example type of signaling may be referenced as UE-specific signaling. One of these two types of signaling or a combination of the two types of signaling may be used to transmit a timing realignment indication message. The timing realignment indication message may be shown to notify one or more UEs 110 of a configuration of a timing reference point. References, hereinafter, to the term “UE 110” may be understood to represent reference to a broad class of generic wireless communication devices within a cell (i.e., a network receiving node, such as a wireless device, a sensor, a gateway, a router, etc.), that is, being served by the TRP 170. A timing reference point is a timing reference instant and may be expressed in terms of a relative timing, in view of a timing point in a frame, such as (starting or ending boundary of) a symbol, a slot or a sub-frame within a frame; or a frame. For a simple description in the following, the term “a frame boundary” is used to represent a boundary of possibly a symbol, a slot or a sub-frame within a frame; or a frame. Thus, the timing reference point may be expressed in terms of a relative timing, in view of a current frame boundary, e.g., the start of the current frame. Alternatively, the timing reference point may be expressed in terms of an absolute timing based on certain standards timing reference such as a GNSS (e.g., GPS), Coordinated Universal Time (“UTC”), etc. In the absolute timing version of the timing reference point, a timing reference point may be explicitly stated.

The timing reference point may be shown to allow for timing adjustments to be implemented at the UEs 110. The timing adjustments may be implemented for improvement of accuracy for a clock at the UE 110. Alternatively, or additionally, the timing reference point may be shown to allow for adjustments to be implemented in future transmissions made from the UEs 110. The adjustments may be shown to cause realignment of transmitted frames at the timing reference point. Note that the realignment of transmitted frames at the timing reference point may comprise the timing realignment from (the starting boundary of) a symbol, a slot or a sub-frame within a frame; or a frame at the timing reference point for one or more UEs and one or more BSs (in a cell or a group of cells), which applies across the application below.

At UE 110 side, the UE 110 may monitor for the timing realignment indication message. Responsive to receiving the timing realignment indication message, the UE 110 may obtain the timing reference point and take steps to cause frame realignment at the timing reference point. Those steps may, for example, include commencing transmission of a subsequent frame at the timing reference point.

Furthermore, or alternatively, before monitoring for the timing realignment indication message, the UE 110 may cause the TRP 170 to transmit the timing realignment indication message by transmitting, to the TRP 170, a request for a timing realignment, that is, a timing realignment request message. Responsive to receiving the timing realignment request message, the TRP 170 may transmit, to the UE 110, a timing realignment indication message including information on a timing reference point, thereby allowing the UE 110 to implement a timing realignment (or/and a timing adjustment including clock timing error correction), wherein the timing realignment is in terms of (e.g., a starting boundary of) a symbol, a slot or a sub-frame within a frame; or a frame for UEs and base station(s) in a cell (or a group of cells).

According to aspects of the present application, a TRP 170 associated with a given cell may transmit a timing realignment indication message. The timing realignment indication message may include enough information to allow a receiver of the message to obtain a timing reference point. The timing reference point may be used, by one or more UEs 110 in the given cell, when performing a timing realignment (or/and a timing adjustment including clock timing error correction).

According to aspects of the present application, the timing reference point may be expressed, within the timing realignment indication message, relative to a frame boundary (where, as previously described and to be applicable below across the application, a frame boundary can be a boundary of a symbol, a slot or a sub-frame with a frame; or a frame). The timing realignment indication message may include a relative timing indication, Δt. It may be shown that the relative timing indication, Δt, expresses the timing reference point as occurring a particular duration, i.e., Δt, subsequent to a frame boundary for a given frame. Since the frame boundary is important to allowing the UE 110 to determine the timing reference point, it is important that the UE 110 be aware of the given frame that has the frame boundary of interest. Accordingly, the timing realignment indication message may also include a system frame number (SFN) for the given frame.

It is known, in 5G NR, that the SFN is a value in range from 0 to 1023, inclusive. Accordingly, 10 bits may be used to represent a SFN. When a SFN is carried by an SSB, six of the 10 bits for the SFN may be carried in a Master Information Block (MIB) and the remaining four bits of the 10 bits for the SFN may be carried in a Physical Broadcast Channel (PBCH) payload.

Optionally, the timing realignment indication message may include other parameters. The other parameters may, for example, include a minimum time offset. The minimum time offset may establish a duration of time preceding the timing reference point. The UE 110 may rely upon the minimum time offset as an indication that DL signaling, including the timing realignment indication message, will allow the UE 110 enough time to detect the timing realignment indication message to obtain information on the timing reference point.

The transmitting apparatus and the receiving apparatus may be different devices in different communication scenarios, which is not limited in the present disclosure. For example, in downlink communication, the transmitting apparatus may be a network device such as BS, and the receiving apparatus may be a terminal device such as UE. In uplink communication, the transmitting apparatus may be a terminal device such as UE, and the receiving apparatus may be a network device such as BS. In sidelink communication, the transmitting apparatus and the receiving apparatus may both be terminal devices such as UEs.

Various embodiments of the present disclosure will be described below by way of example. The following embodiments will be illustrated by taking an example where the transmitting apparatus or encoding apparatus is a BS and the receiving apparatus or decoding apparatus is a UE. Reference is now made to FIG. 7, which shows a signaling chart for data transmission according to some embodiments of the present disclosure. The signaling chart involves the BS and the UE.

In step 701, the BS transmits information indicating a first set of resources and a second set of resources, the first set of resources for transmitting the first data transmission, and the second set of resources for transmitting the second data transmission. The first set of resources and the second set of resources are at least partially overlapped. Accordingly, the UE receives the information.

The first set of resources and the second set of resources may partially overlap in time domain, frequency domain, spatial domain (e.g., layer(s)), or code-domain. The code domain resource includes, but is not limited to, codebook, codeword, code sequence, interleaver, and mapping pattern.

In some embodiments, the first data transmission may only occupy a part of the first set of resources, and the second data transmission may only occupy a part of the second set of resources.

In an implementation, the second set of resources may be subset of the first set of resources.

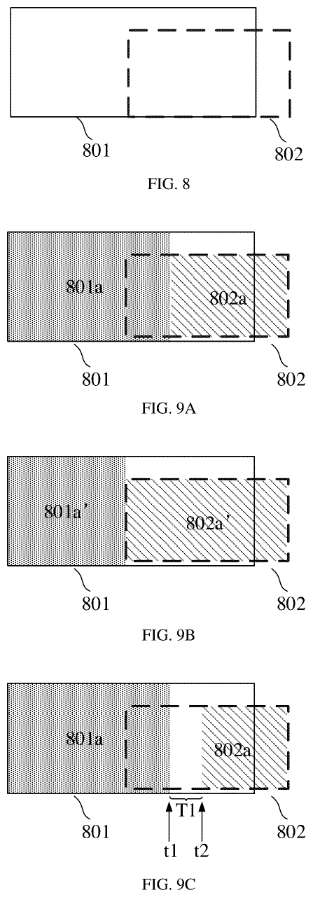

For example, referring to FIG. 8, the BS transmits information indicating resource 801 (the rectangle shown in solid line) and resource 802 (the rectangle shown in dashed line), and resource 801 and resource 802 are for different Physical Downlink Shared Channel (PDSCH) transmissions. For example, resource 801 is for transmitting PDSCH1 (an example of the first data transmission), and resource 802 is for transmitting PDSCH2 (an example of the second data transmission). In addition, resource 801 and resource 802 are at least partially overlapped. In such case, resource assigned to PDSCH1 and resource assigned to PDSCH2 are at least partially overlapped.

The information may be transmitted via control information such as downlink control information (DCI), which is not limited in the present disclosure.

The first data transmission may be for one or more CB(s), CBG(s) or TB(s), and the second data transmission may be for another set of one or more CB(s) one or more CB(s), CBG(s) or TB(s), which is not limited in the present disclosure.

The first data transmission and the second data transmission may be transmitted to the same UE or different UEs. The following embodiments will be illustrated by taking an example where the first data transmission and the second data transmission are transmitted to the same UE.

In step 702, the BS transmits the first data transmission on the first set of resources. Accordingly, the UE receives the first data transmission on the first set of resources.

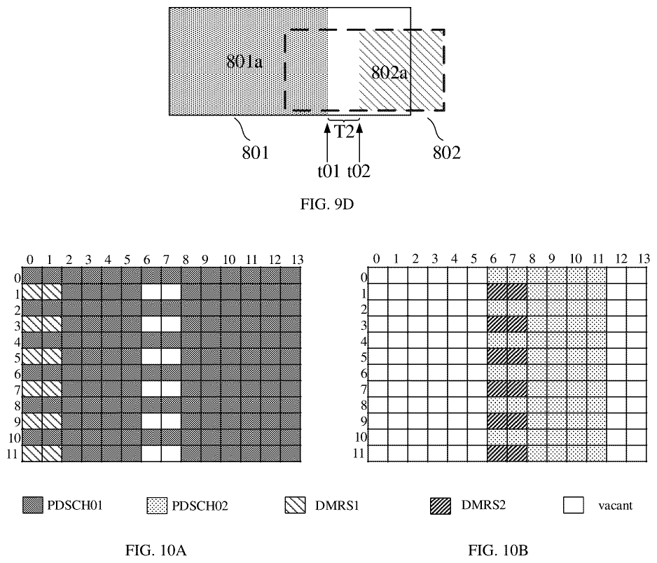

For example, referring to FIG. 9A, the BS starts to transmit PDSCH1 at the beginning of resource 801. Accordingly, the UE starts to receive PDSCH1. Note that PDSCH1 transmission may not occupy the whole resource 801.

In step 705, the BS transmits the second data transmission on the second set of resources in a case where a condition is satisfied. Accordingly, the UE receives the second data.

In an implementation, the condition may be detecting a first signal indicating the second data transmission is to be transmitted on the second set of resources.

Referring again to FIG. 7, in step 703, the UE may transmit a first signal indicating the second data transmission is to be transmitted on the second set of resources. Accordingly, the BS may detect the first signal.

The UE may transmit the first signal in a case where the second set of resources are vacant or at least part of the second set of resources are vacant.

For example, referring again to FIG. 9A, PDSCH1 transmission occupies the part 801a (filled in gray) which is a part of resource 801. In such case, since the part 801a is overlapped with resource 802, PDSCH1 transmission also occupies a part of resource 802.

Since PDSCH1 transmission only occupies a part of resource 802, the remaining part (i.e., the part 802a filled with diagonal lines) of resource 802 is vacant. Therefore, the part 802a may be used for other data transmission. In such case, the UE may transmit the first signal to the BS, informing the BS that PDSCH2 is allowed to be transmitted on the part 802a. Once the BS receives the first signal, it may know that there are resource for PDSCH2 transmission. Accordingly, the BS may start to transmit PDSCH2 on the part 802a.

This first signal may be carried in UCI or MAC Control Element (MAC CE) or RRC, which is not limited in the present disclosure.

In another implementation, the condition may be detecting a second signal indicating the first data transmission is stopped.

Once the first data transmission is stopped, in step 703, the UE may transmit to the BS the second signal indicating the first data transmission is stopped. Accordingly, the BS may detect the second signal. This step is optional.

The first data transmission is stopped may refer to that the first data transmission is complete, terminate, or interrupted. The first data transmission may be interrupted by internal instruction from the UE itself or external instruction from other device(s).

For internal instruction, it may be due to successful decoding of the first data or the UE requesting the second data transmission which is more urgent or has a higher priority than the first data transmission and thus the UE may request to interrupt the first data transmission. For external instruction, it may be due to another UE requesting the second data transmission which is more urgent or has a higher priority than the first data transmission and thus the first data transmission is interrupted.

Once the BS detects the second signal, it will know that the first data transmission is stopped, and there will be resource for the second data transmission. The BS may then start to transmit the second data transmission. Accordingly, the UE may receive the second data transmission.

For example, referring again to FIG. 9A, transmission of PDSCH1 is interrupted by the end of the part 801a, and the UE accordingly transmits the second signal to the BS. Once the BS detects the second signal, it may know that transmission of PDSCH1 is stopped and the part 802a is vacant. The BS may then transmit PDSCH2 on the part 802a.

In an example, both PDSCH1 and PDSCH2 are for the same UE. While the BS is transmitting PDSCH1 to the UE, if PDSCH2 is more urgent than PDSCH1, the UE may stop receiving PDSCH1 and transmit to the BS the second signal indicating the first data transmission is stopped. Upon receiving the second signal, the BS may stop sending PDSCH1 and start to transmit PDSCH2 to the UE.

In another example, PDSCH1 and PDSCH2 are for different UEs (e.g., UE1 and UE2). While the BS is transmitting PDSCH1 to UE1, if PDSCH2 is more urgent than PDSCH1, UE2 may interrupt UE1 from receiving PDSCH1. UE1 may then transmit to the BS the second signal indicating the first data transmission is stopped. Upon receiving the second signal, the BS may stop sending PDSCH1 to UE1 and start to transmit PDSCH2 to UE2.

In yet another implementation, the condition may be receiving a feedback indicating the first data is successfully decoded.

The UE may decode the first data while receiving the first data transmission. Once the first data is successfully decoded, in step 703, the UE may transmit to the BS a positive feedback indicating the successful decoding of the first data. Accordingly, the BS may receive the positive feedback. This step is optional.

In such case, once the BS receives the positive feedback, it may know that the first data is successfully decoded. In such case, the BS may stop transmitting the first data transmission then start transmitting the second data transmission. Accordingly, the UE may receive the second data transmission.

For example, referring again to FIG. 9A, PDSCH1 is successfully decoded by the end of the part 801a, and the UE accordingly transmits to the BS an ACK indicating the successful decoding of PDSCH1. Once the BS receives the feedback, it may know that PDSCH1 is successfully decoded and the part 802a is vacant. The BS may then transmit PDSCH2 on the part 802a.

Optionally, before step 701, the BS may pre-configure and signal multiple uplink resources for feedback, so that the UE may transmit the feedback in the earliest feedback opportunity after successful decoding.

For example, the BS may send to the UE configuration information indicating feedback timings. The feedback timings refer to time domain resources for UCI (e.g., ACK or NACK) transmission. The UE may transmit feedbacks at any of the feedback timings. For example, the UE may transmit an ACK at the earliest feedback timing (that is, the feedback timing immediate after the successful decoding of PDSCH 1) once PDSCH1 is successfully decoded. Accordingly, the BS may receive the ACK.

The configuration information may be signaled via RRC signaling, which is not limited in the present disclosure.

In yet another implementation, the condition may be that a priority of the second data transmission is higher than a priority of the first data transmission. In such case, the overlapped part of the first set of resources and the second set of resources may be used for the second data transmission instead of being used for the first data transmission. In some cases, the first data transmission which is of lower priority may be punctured by the second data transmission which is of higher priority.

For example, referring to FIG. 9B, the BS starts to transmit PDSCH1 on resource 801. If the priority of PDCSH2 transmission is higher than PDCSH1 transmission, the overlapped part of resource 801 and resource 802 may be used for PDCSH2 transmission. In other words, PDCSH1 is transmitted over the part 801a′ which is the resource actual used for PDCSH1 transmission. The part 801a′ is a part of resource 801, and the part 801a is not overlapped with resource 802. Moreover, the BS may start to transmit PDCSH2 at the beginning of resource 802. The transmission of PDSCH1 may be punctured or interrupted by the transmission of PDCSH2 if PDSCH1 transmission is not complete before the beginning of resource 802.

On the other hand, if the priority of the second data transmission is not higher than the priority of the first data transmission which is the incumbent transmission, the first data transmission will not be punctured by the second data transmission. In such case, the incumbent transmission with a higher priority will be guaranteed.

The priority of the first data transmission and the priority of the second data transmission may be each indicated by a respective priority index. Alternatively, the priority of the first data transmission and the priority of the second data transmission may be each indicated by a respective priority ID.

The BS may transmit a fifth indication for indicating the priority index of the first data transmission, the priority index of the second data transmission, or the priority index of the first data transmission and the priority index of the second data transmission. In this way, after receiving the priority index of the first data transmission and the second data transmission respectively, the UE may know the respective priority of the first data transmission and the second data transmission. Moreover, as described above, since the overlapped part of the first set of resources and the second set of resources will be used for the data transmission with a higher priority, after receiving the fifth indication, the UE may know that which one of the first data transmission and the second data transmission will be transmitted over the overlapped part of the first set of resources and the second set of resources. It will be appreciated that the first data transmission and the second data transmission may be for different UEs.

The fifth indication may be carried in a control signal such as an RRC signaling, which is not limited in the present disclosure.

The priority of the first data transmission may be based on at least one of: payload content of the first data transmission, a channel quality of a channel for transmitting the first data transmission, transmission mode for transmitting the first data transmission, bandwidth part for transmitting the first data transmission, antenna configuration for transmitting the first data transmission, device capability for receiving the first data transmission.

Similarly, the priority of the second data transmission may be based on at least one of: a payload content of the second data transmission, a channel quality of a channel for transmitting the second data transmission, a transmission mode for transmitting the second data transmission, a bandwidth part for transmitting the second data transmission, an antenna configuration for transmitting the second data transmission, or a device capability for receiving the second data transmission.

In the case where the priority of the data transmission is based on payload content, there may be two types of payload content, one is application-layer data and the other is control message. The control message is sent as MAC CE or RRC in data channel rather than control channel. In such case, the control message has a higher priority than the application-layer data.

In the case where the priority of the data transmission is based on channel quality, the data transmission with higher channel quality has a higher priority.

In the case where the priority of the data transmission is based on transmission mode, in an example, transmission mode with higher reliability has a higher priority. In another example, lossless transmission mode has a higher priority than lossy transmission mode. In lossless transmission mode, each CB or TB may be expected to be decoded correctly, while in lossy transmission mode, certain level packet loss may be tolerated.

In the case where the priority of the data transmission is based on bandwidth part, the data transmission that is allocated with wider bandwidth has a higher priority.

Antenna configurations may be related to the number of transmitting or receiving ports, or the number of MIMO layers. In the case where the priority of the data transmission is based on antenna configurations, in an example, data transmission with greater number of transmitting or receiving ports has a higher priority. In another example, data transmission with greater number of MIMO layers has a higher priority.

In the case where the priority of the data transmission is based on device capability, in an example, data transmission for a high-end device has a higher priority than and low-end device. The low-end device may be a reduced-capability (RedCap) device which can only process data of a relatively low data rate. Moreover, the low-end device may be a low-power IoT device that operates with relatively low complexity.

Compared to conventional solutions, in the present disclosure, data transmission on overlapped resources is conditionally scheduled, and thus improving flexibility of data transmission.

In an example, compared to contention-based transmission where first-come-first-serve scheme is adopted, in the present disclosure, the incumbent transmission may be punctured by another data transmission with high priority.

In another example, compared to pre-emotion transmission where the incumbent transmission is always punctured and resource allocated for the newly scheduled transmission is indicated after transmission, in the present disclosure, scheduling for different data transmissions are pre-configured and signaled in advance (e.g., before the transmission), and the incumbent transmission may not always be punctured (e.g., in the case where the incumbent transmission has a higher priority).

In yet another implementation, the condition may be that a channel quality of a channel for transmitting the second data transmission is above a threshold.

For example, the BS starts to transmit PDSCH1 on resource 801. If the channel quality of the channel for PDSCH2 transmission is above a threshold, the overlapped part of resource 801 and resource 802 may be used for PDCSH2 transmission. In other words, the BS may start to transmit PDCSH2 at the beginning of resource 802. In some cases, the transmission of PDSCH1 may be punctured or interrupted by the transmission of PDCSH2 if PDSCH1 transmission is not complete before the beginning of resource 802.

Since the overlapped part of resource 801 and resource 802 are preferentially assigned to PDSCH2 transmission with high channel quality, the system throughput may be improved.

In some cases, the proposed scheme is backward compatible, and the BS may enable the UE to adopt the proposed scheme by transmitting a first indication to the UE.

In some embodiments, in step 700, the BS may transmit a first indication enabling receiving of the second data transmission on the second set of resources in the case where the condition is satisfied. Accordingly, the UE may receive the first indication. Step 700 may be performed before step 701, and it is optional.

In some embodiments, in step 704, the BS may transmit a third signal indicating the second data transmission is to be transmitted on the second set of resources or the second data transmission is being transmitted on the second set of resources. This step is optional. In one example, if the UE has performed step 703, the BS may or may not perform step 704. In another example, the BS perform step 704 even the UE has not performed step 703.

The third signal may be a reference signal or a synchronization signal, which is not limited in the present disclosure.

The third signal may be reference signal such as a demodulation reference signal (DMRS), a channel state information-reference signal (CSI-RS), a sounding reference signal (SRS), or a phase tracking reference signal (PT-RS). The third signal may be synchronization signal such as a primary synchronization signal (PSS) or a secondary synchronization signal (SSS).

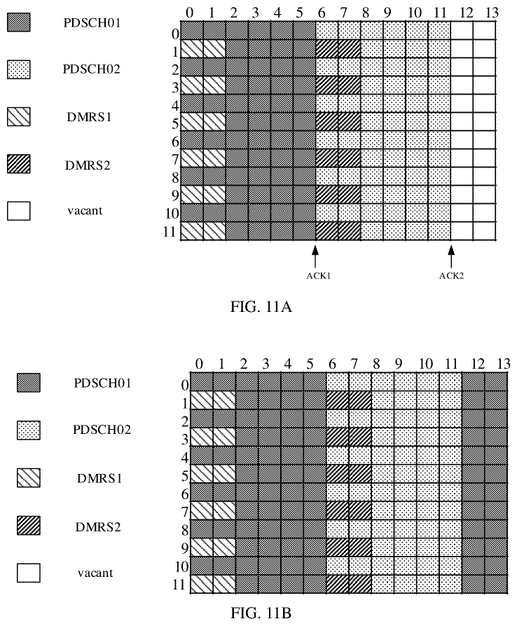

Resources allocated for different data transmissions are shown in FIGS. 10A and 10B. For example, referring to FIG. 10A, resource 1 (sub-carriers 0-11 and symbols 1-13) are assigned for PDSCH01. Moreover, sub-carriers 1, 3, 5, 7, 9, 11 and symbols 0, 1 are for DMRS1 indicating transmission for PDSCH01. Referring to FIG. 10B, resource 2 (sub-carriers 0-11 and symbols 6-11) are assigned for PDSCH02. Moreover, sub-carriers 1, 3, 5, 7, 9, 11 and symbols 6, 1 are for DMRS2 indicating transmission for PDSCH02. In such case, the resources assigned for PDSCH01 and PDSCH02 are overlapped.

Once the UE detects DMRS1 on symbols 0-1, the UE may know that PDSCH01 is to be transmitted on resource 1 or is being transmitted on resource 1. The UE may then start to receive PDSCH01 on resource 1. Moreover, the UE may decode PDSCH01 while receiving PDSCH01.

In some embodiments, the BS may transmit the third signal in the case where the condition described above is satisfied. In an implementation, the BS may transmit the third signal if it detects the feedback indicating the first data (i.e., the first data transmission) is successfully decoded.

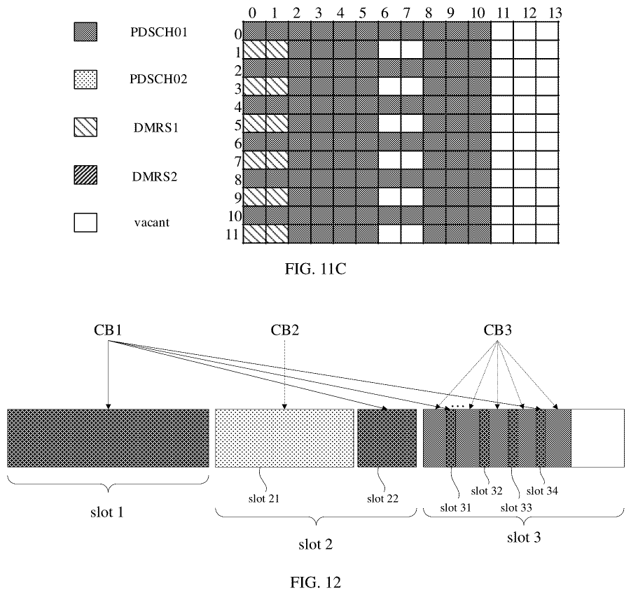

As shown in FIG. 11A, the UE reports ACK1 indicating PDSCH01 is successfully decoded at the earliest feedback timing once it decodes PDSCH01 successfully. For example, PDSCH01 is successfully decoded at the end of symbol 5, the UE then reports ACK1 indicating the successful decoding of PDSCH01 at the end of symbol 5.

Referring again to FIG. 11A, upon receiving ACK1 from the UE at the end of symbol 5, the BS may stop transmitting PDSCH01 and then start to transmit both DMRS2 and PDSCH02 to the UE on resource2. For example, the BS may transmit DMRS2 and PDSCH02 on symbol 6 and the subsequent symbols. DMRS2 indicates that PDSCH2 is to be transmitted to the UE or PDSCH2 is being transmitted to the UE.

In some embodiments, the BS may start to transmit the third signal before it start to transmit the second data transmission. Alternatively, the BS may start to transmit the third signal and the second data transmission at the same time, which is not limited in the present disclosure.

In an implementation, the BS may transmit the third signal on a first N time domain resources of the second set of resources, where N is a positive integer. The first N time domain resources may be the first few slots, mini-slots, multi-slots, symbols, symbol groups or TTIs of the second set of resources, which is not limited in the present disclosure.

In an example where N=2, the BS transmits the third signal on the first N time domain resources of the second set of resources. Referring again to FIG. 11A, the BS transmits DMRS2 on symbols 6-7 which are the first two symbols of resource 2. In some cases, DMRS2 may be transmitted on some sub-carriers of resource 2. For example, DMRS2 is transmitted on sub-carriers 1, 3, 5, 7, 9, 11 and symbols 6, 7.

If DMRS2 is detected on symbols 6-7, the UE assumes that the BS is to transmit PDSCH02 or the BS is transmitting PDSCH02 on resource 2 (i.e., symbol 6 and the subsequent symbols). The UE may then start to receive and decode PDSCH02 symbol 6 and the subsequent symbols. The UE may decode while receiving PDSCH02.

Once the UE decodes PDSCH02 successfully, it will reports ACK2 at the earliest feedback timing. For example, PDSCH 2 is successfully decoded at the end of symbol 10. The UE then reports ACK2 at the beginning of symbol 11.

In an implementation, the BS may transmit the third signal if the priority of the second data transmission is higher than the priority of the first data transmission.

For example, referring to FIG. 11B, in the case where the priority of PDSCH02 is higher than the priority of PDSCH01, the BS may stop transmitting PDSCH01 at the end of symbol 5. Then the BS may transmit DMRS2 on symbols 6-7, and may transmit PDSCH02 on symbol 6 and the subsequent symbols.

Accordingly, the UE detects DMRS2 on symbols 6-7, and it assumes that BS is to transmit PDSCH02 or is transmitting PDSCH02 on symbols 6 and the subsequent symbols. The UE then starts to receive and decode PDSCH02. The UE may decodes while receiving PDSCH2.

Once the UE decodes PDSCH02 successfully, it will report ACK2 at the earliest feedback timing. For example, PDSCH02 is successfully decoded at the end of symbol 11. The UE then reports ACK2 indicating the successful decoding of PDSCH02. After receiving ACK2, the BS may terminate the transmission of PDSCH02.

In a case where PDSCH02 is not successfully decoded by the end of symbol 11, the BS will terminate transmitting PDSCH 2 at the end of symbol 11 and may wait for a next vacant resource for PDSCH02 transmission.

In a case where PDSCH01 is not successfully decoded by the end of symbol 5, transmission of PDSCH01 may be punctured by PDSCH02. That is, the BS may stop transmitting PDSCH01 and start to transmit both DMRS2 and PDSCH2 to the UE even PDSCH01 is not successfully decoded by the end of symbol 5. Thus, the transmission performance of PDSCH2 with higher priority may be improved.

The BS may continuously transmit PDSCH01 on the remaining resources for PDSCH01 transmission in the case where PDSCH01 is not successfully decoded by the end of symbol 5. For example, referring again to FIG. 11B, the BS may continuously transmit PDSCH01 on symbols 12-13.

In some embodiments, before transmitting the third signal, the BS may send a second indication indicating the resources for transmitting the third signal. Accordingly, the UE may receive the second signal. This step is optional.

In this way, after receiving the second indication, the UE will know on which resources the third signal may be transmitted, and the UE may monitor the third signal on certain resources.

For example, referring again to FIG. 11A, the BS sends the second indication indicating symbols 6-7 are for transmission of the third signal. After receiving the second indication, the UE may know that DMRS2 may be transmitted on symbols 6-7. Accordingly, the UE may try to monitor DMRS2 on symbols 6-7. In such case, symbols 6-7 are also referred to as boundary timing between the two PDSCHs (i.e., PDSCH01 and PDSCH02).

The second indication may be signaled via control signal such as RRC signaling.

In some embodiments, the BS may not transmit the third signal in the case where the condition described above is not satisfied. In an implementation, the BS may not transmit the third signal if it does not detect the feedback indicating the first data is successfully decoded.

Referring to FIG. 11C, PDSCH01 is not successfully decoded until the end of symbol 10. In such case, the UE may not feedback an ACK until the end of symbol 10. The BS may not receive the ACK before the beginning of the resource 2. Since the BS does not receive an ACK before symbol 6, it may not transmit DMRS2 on symbols 6-7, and PDSCH02 will not be transmitted. Accordingly, the UE may not detect DMRS2 and it may know that PDSCH02 will not be transmitted.

In some cases, the UE may start to receive the second data transmission after a pre-configured or agreed time gap. The agreed time gap is between the ACK feedback timing and the beginning of second transmission.

In some embodiments, the BS may send a third indication indicating a first time gap between a transmission time of the feedback and a start time at which the second data transmission is to be transmitted. Accordingly, the UE may receive the third indication. In this way, the UE may determine the receiving time of the second data transmission. This step is optional.

The first time gap may be related to BS processing capability, roundtrip time. The agreed time gap may be pre-configured in RRC, or indicated by DCI.

For example, referring to FIG. 9C, resource 801 is for transmitting PDSCH1, and resource 802 is for transmitting PDSCH2. PDSCH1 and PDSCH2 are transmitted to the same UE. In addition, the third indication indicates that T1 is the time gap between the transmission time of the feedback indicating PDSCH1 is successfully decoded and the start time at which PDSCH2 is to be transmitted.

For example, PDSCH1 is successfully decoded at the end of the part 801a. The UE then transmits an ACK indicating the successful decoding of PDSCH1 at the end of the part 801a which is the earliest feedback timing (e.g., t1). In such case, the UE may start to receive PDSCH2 at time t2, and t2=t1+T1. In this way, the UE may determine the time at which to receive PDSCH2. PDSCH2 will be received by the UE once it arrives at the UE.

In some embodiments, the first data transmission and the second data transmission are transmitted to different UEs. The first data transmission may be transmitted to a first UE, and the second data transmission may be transmitted to a second UE.

In an implementation, while the BS is transmitting the first data transmission to the first UE, the second UE may transmit a first signal indicating the second data transmission is to be transmitted on the second set of resources. For example, while the BS is transmitting the first data transmission to the first UE, the second UE may have some urgent download transmission. In such case, the second UE may request the second data transmission by transmitting the first signal to the BS. After receiving the first signal, the BS may stop transmitting the first data transmission to the first UE and start to transmit the second data transmission to the second UE.

In some cases, the second UE may monitor or listen for feedback(s) from the first UE. The second UE may receive the second data transmission on the second set of resources in a case where it detects a feedback indicating the first data transmission is successfully decoded.

As described above, the BS may pre-configure and signal multiple uplink resources for feedback. In some embodiments, the BS may broadcast to both the first UE and the second UE the feedback resource assignment indicating the multiple uplink resources for feedback. In such case, the second UE may know the feedback resource on which the feedback from the first UE may be transmitted. Accordingly, the second UE may monitor the feedback from the first UE on certain resources.

In an implementation, the feedback (e.g., ACK or NACK) payload or CRC bits are scrambled by a sequence of bits (e.g., group RNTI) known to the BS, the first UE and the second UE, such that the ACK from the first UE will be decodable at both the BS and the second UE. In this way, both the BS and the second UE may know the decoding result of the first data transmission which is decoded by the first UE.

Once the secondary UE detects an ACK from the primary UE, it may start to receive the secondary transmission. In some embodiments, the UE may start to receive the secondary transmission after an agreed time gap.

In some embodiments, the BS may send a fourth indication indicating a second time gap between a detection time of the feedback and the start time at which the second data transmission is to be transmitted. Accordingly, the UE may receive the third indication. In this way, the UE may determine the receiving time of the second data transmission. This step is optional.

The second time gap may be based on the BS processing capability, the roundtrip time between the BS and both the first UE and the second UE.

The roundtrip time here may refer to the summation of the time it takes for a control signal or data signal to be transmitted from the first UE to the BS and the time it takes for a control signal or data signal to be transmitted from the BS back to the second UE. The roundtrip time may be in milliseconds.

For example, the time it takes for a control signal or data signal to be transmitted from the first UE to the BS is T01, and the time it takes for a control signal or data signal to be transmitted from the BS back to the second UE is T02. In such case, the roundtrip time is calculated as T01+T02.

The fourth indication may be signaled via control signal such as RRC or DCI.

For example, referring to FIG. 9D, resource 801 is for transmitting PDSCH1, and resource 802 is for transmitting PDSCH2. PDSCH1 is transmitted to UE1, and PDSCH2 is transmitted to UE2. In addition, the fourth indication indicates that T2 is the time gap between the detection time of the feedback indicating PDSCH1 is successfully decoded and the start time at which PDSCH2 is to be transmitted.

For example, PDSCH1 is successfully decoded at the end of the part 801a. UE1 then transmits an ACK indicating the successful decoding of PDSCH1 at the end of the part 801a which is the earliest feedback timing (e.g., t01). Moreover, UE2 may start to receive PDSCH2 at time t02, and t02=t01+T2. In this way, UE 2 may determine the time at which to receive PDSCH2. PDSCH2 will be received by the UE once it arrives at the UE.

The first data transmission and the second data transmission may be transmitted to the same UE or different UEs.

The first data transmission may be for a set of first UEs, and the second data transmission may be for a set of second UEs. For example, the first data transmission is broadcasted to a set of first UEs with the same priority, and the second data transmission is broadcasted to a set of second UEs with the same priority.

The following embodiments will be illustrated by taking an example where different code blocks (CBs) are transmitted during different data transmissions.

Referring to FIG. 12, slot 2 consists of slot 21 and slot 22. Before sending redundancy versions RVs of CB1 and RV(s) of CB2, the BS may schedule slot 1 and a part of slot 2 (e.g., slot 22) for CB1, and may schedule slot 2 for CB2. In such case, the resource scheduled for CB1 overlaps with the resource scheduled for CB2 on slot 22. An RV refers to a set of bits of a CB.

In an implementation, although slot 2 is scheduled for CB 2, the BS may stop transmitting CB2 at the end of slot 21, and may not transmit CB 2 on slot 22. In this case, since slot 22 has also been scheduled for CB1, the BS may transmit CB1 on slot 22. In this way, the resources may be utilized efficiently. In another implementation, the BS may not stop transmitting CB2 until the end of slot 22. In this case, although slot 22 has also been scheduled for CB1, it cannot be used to transmit CB1, because the condition that the second resource should be vacant (i.e., slot 22 is not occupied by CB2) is not satisfied.

In another example shown in FIG. 12, before sending RV(s) of CB1 and RV(s) of CB3, the BS may schedule slot 1 and a part of slot 3 (e.g., slot 31, slot 32, slot 33 and slot 34) for CB1, and may schedule slot 3 for CB3. In such case, the resource scheduled for CB1 overlaps with the resource scheduled for CB3 on slot 31, slot 32, slot 33, and slot 34.

In an implementation, although slot 3 is scheduled for CB 3, the BS may stop transmitting CB3 before slot 32, and may no longer transmit CB3. In this case, since slot 32, slot 33 and slot 34 have also been scheduled for CB1, the BS may transmit CB1 on at least one of slot 32, slot 33 and slot 34. In this way, the resources may be utilized efficiently. In another implementation, the BS may not stop transmitting CB3 by the end of slot 34. In this case, although slot 31, 32, 33, and 34 have also been scheduled for CB1, they cannot be used to transmit CB2, because the condition that the second resource should be vacant (i.e., slot 31, 32, 33, and 34 are not occupied by CB3) is not satisfied.

In some embodiments, the BS sends the one or more sets of bits of the first codeword on a second part of the second resource in a case where the first codeword has not been successfully decoded on the first resource and/or the second codeword has been successfully decoded on the first part of the second resource. In such case, the transmission of the first codeword on one or more resources is conditionally scheduled. The scheduling information indicating resources for transmission of the first codeword may be potential channel resource positions. For example, the scheduling information may indicate symbols indices, subcarrier positions for continued transmission of the first codeword, conditioned on the outcome that the second codeword is correctly decoded or early terminated.

Referring again to FIG. 12, the BS may schedule slot 1 and a part of slot 2 (e.g., slot 22) for CB1, and may schedule slot 2 or slot 21 for CB2.

In an implementation, the BS sends RV(s) of CB1 on slot 22 in a case where CB1 has not been successfully decoded on slot 1 (the BS may receive a NACK corresponding to CB 1 which is optional) and/or CB 2 has been successfully decoded on slot 21 which frees up channel resource for transmitting CB1 (the BS may receive an ACK corresponding to CB 2). In such case, CB 1 may be transmitted on slot 22 which provides more opportunities for transmission of CB1.

In another implementation, CB1 is conditionally scheduled in slot 22, while CB2 is unconditionally scheduled in slot 22. In such case, slot 22 will be prioritized for CB2. For example, if transmission of CB2 is not finished by the end of slot 21, then the BS will continue to transmit CB2 in slot 22. In this case, slot 22 will not be used to transmit CB1, because CB1 is conditionally scheduled in slot 22, while CB2 is unconditionally scheduled in slot 22, and the condition that the second resource should be vacant (i.e., slot 22 is not occupied by CB2) is not satisfied. In this way, transmission of CB 2 will not be interrupted or affected by transmission of CB 1.

In another example shown in FIG. 12, the BS may schedule slot 1 and a part of slot 3 (e.g., slot 31, slot 32, slot 33 and slot 34) for CB1, and may schedule slot 3 or part of slot 3 for CB3.

In an implementation, the BS may send RV(s) of CB1 on slot 32, slot 33 and slot 34 in a case where CB1 has not been successfully decoded on slot 1 (the BS may receive a NACK corresponding to CB 1 which is optional) and/or CB 3 has been successfully decoded before slot 32 which frees up channel resource for transmitting CB1 (the BS may receive an ACK corresponding to CB 3). In such case, CB 1 may be transmitted on at least one of slot 32, slot 33 and slot 34 which provides more opportunities for transmission of CB1.

In another implementation, CB1 is conditionally scheduled in slot 31, slot 32, slot 33 and slot 34, while CB3 is unconditionally scheduled in slot 3 which includes slot 31, slot 32, slot 33 and slot 34. In such case, slot 31, slot 32, slot 33 and slot 34 will be prioritized for CB3. For example, if transmission of CB3 is not finished before the beginning of slot 34, then the BS will continue to transmit CB3 in slot 34. In this case, slot 31, slot 32, slot 33 and slot 34 will not be used to transmit CB1, because CB1 is conditionally scheduled in slot 31, slot 32, slot 33 and slot 34, while CB3 is unconditionally scheduled in slot 31, slot 32, slot 33 and slot 34, and the condition that the second resource should be vacant (i.e., at least one of slot 31, slot 32, slot 33 and slot 34 is not occupied by CB3) is not satisfied. In this way, transmission of CB 3 will not be interrupted or affected by transmission of CB 1.

In this way, a codeword which has not been successfully decoded may be transmitted on subsequent slots without effecting other codewords. In addition, compared to IR-HARQ where transmission of the codeword are deterministically scheduled by one or more separate DCIs, the transmission of the codeword on one or more resources in the present disclosure may be one-time pre-configured. Therefore, less indications will be used for scheduling transmission of the codeword, transmission latency may be reduced, and power may be saved.

In some embodiments, if the first codeword and the second codeword are transmitted to the same UE, the UE may try to decode the second codeword once the first codeword is successfully decoded. If the first codeword and the second codeword are transmitted to the different UEs, the UE which receives the first codeword may listen to the ACK or NACK of the second codeword sent from another UE. In any case, if the second codeword is successfully decoded, the UE will assume that the second part of the second resource is now scheduled for it and perform receiving or transmission of the first codeword. Otherwise if the second codeword is not successfully decoded, the UE will assume that the second part of the second resource is still scheduled for the second codeword.

In some embodiments, the BS may indicate the first resource and part of the second resource for the first codeword through control signaling. The BS may indicate the first resource and part of the second resource for the first codeword in the DCI through the two fields: frequency domain resource assignment and time domain resource assignment.

In an implementation, in each of the field, multiple resource assignment information corresponds to the multiple resource positions is indicated. A second (or subsequent) resource assignment information may be indicated by a frequency or time offset with respect to the frequency or time resources of the first resource, and its bandwidth or duration.

In the case of frequency domain resource assignment, the offset B can be specified in terms of bandwidth part (BWP) or number of subcarriers.

In the case of time domain resource assignment, the offset S and duration L can be specified in terms of number of symbols or slots.

The first resource assignment information may be a deterministic resource allocation that is solely for the current packet.

The second (or subsequent) resource assignment information may be a conditional resource allocation that depends on the successful transmission of other packets, and may overlap with another scheduled resource.

In an implementation, one DCI contains more than one field for frequency domain resource assignment, and more than one field for time domain resource assignment.

The first fields for frequency or time resource allocation is a deterministic resource allocation that is solely for the current packet.

The second (or subsequent) fields for frequency or time resource allocation is a conditional resource allocation that depends on the successful transmission of other packets, and may overlap with another scheduled resource.

Note that the additional conditional resource allocation for the second (or subsequent) transmissions only specifies the maximum resource that can be occupied for transmitting the first codeword, but not necessarily the actual resource for transmitting the first codeword. The actually resource used by the first codeword depends on the completion time or successful decoding time of the second codeword.

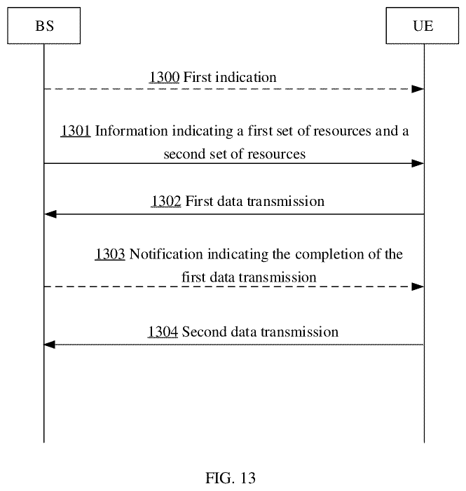

The present disclosure provides another method for data transmission. The following embodiments will be illustrated by taking an example where the transmitter or encoder is a UE and the receiver or decoder is a BS. Reference is now made to FIG. 13, which shows a signaling chart for data transmission according to some embodiments of the present disclosure. The signaling chart involves the BS and the UE.

In step 1301, the BS transmits information indicating a first set of resources and a second set of resources, the first set of resources for transmitting a first data transmission, the second set of resources for transmitting a second data transmission, and the first set of resources and the second set of resources are at least partially overlapped. Accordingly, the UE receives the information.

The first set of resources and the second set of resources may partially overlap in time domain, frequency domain, spatial domain (e.g., layer(s)), or code-domain. The code domain resource includes, but is not limited to, codebook, codeword, code sequence, interleaver, and mapping pattern.

In some embodiments, the first data transmission may only occupy a part of the first set of resources, and the second data transmission may only occupy a part of the second set of resources.

In an implementation, the second set of resources may be subset of the first set of resources.

For example, referring again to FIG. 8, the BS transmits information indicating resource 801 (the rectangle shown in solid line) and resource 802 (the rectangle shown in dashed line), and resource 801 and resource 802 are for different Physical Uplink Shared Channel (PUSCH) transmissions. For example, resource 801 is for transmitting PUSCH1 (an example of the first data transmission), and resource 802 is for transmitting PUSCH2 (an example of the second data transmission). In addition, resource 801 and resource 802 are at least partially overlapped. In such case, resource assigned to PUSCH1 and resource assigned to PUSCH2 are at least partially overlapped.

The information may be transmitted via control information such as downlink control information (DCI), which is not limited in the present disclosure.

The first data transmission may be for one or more CB(s), CBG(s) or TB(s), and the second data transmission may be for another set of one or more CB(s) one or more CB(s), CBG(s) or TB(s), which is not limited in the present disclosure.

The first data transmission and the second data transmission may be transmitted from the same UE or different UEs. The following embodiments will be illustrated by taking an example where the first data transmission and the second data transmission are transmitted from the same UE.

In step 1302, the UE transmits a first data transmission on the first set of resources. Accordingly, the BS receives the first data transmission.

For example, referring again to FIG. 9A, the UE starts to transmit PUSCH1 at the beginning of resource 801. Accordingly, the BS starts to receive PUSCH1. Note that PUSCH1 transmission may not occupy the whole resource 801.

In step 1304, the UE transmits a second data transmission on a second set of resources in a case where a condition is satisfied. Accordingly, the BS receives the second data transmission.

In an implementation, the condition may be receiving a notification indicating the stop of the first data transmission.

The stop of the first data transmission may refer to the completion, termination, or interruption of the first data transmission.

For example, referring again to FIG. 9A, PUSCH1 transmission is complete at the end of the part 801a (filled in gray) which is a part of resource 801. In such case, since the part 801a is overlapped with resource 802, PUSCH1 transmission also occupies a part of resource 802.

After PUSCH1 transmission is complete, in step 1303, the BS may transmit a notification indicating the completion of PUSCH1 transmission. Once the UE receives the notification, it may know that PUSCH1 is successfully decoded and the remaining part (i.e., the part 802a filled with diagonal lines) of resource 802 is vacant. Therefore, the part 802a may be used for other data transmission.

In such case, the UE may stop transmitting PUSCH1 on resource 801 and then start to transmit PUSCH2 on the part 802a. Accordingly, the BS may receive PUSCH2.

In an implementation, the condition may be that the first data transmission is stopped.

The first data transmission is stopped may refer to that the first data transmission is complete, terminate, or interrupted. The first data transmission may be interrupted by internal instruction from the UE itself or external instruction from other device(s).

For internal instruction, it may be due to the arrival of the second data transmission from the UE itself. Moreover, the second is more urgent or has a higher priority than the first data transmission and thus the UE itself would like to terminate or interrupt the first data transmission.

In an example, both PUSCH1 and PUSCH2 are from the same UE. While the UE is transmitting PUSCH1 to the BS, if PUSCH2 is more urgent than PUSCH1, the UE may stop transmitting PUSCH1 and start to transmit PUSCH2 to the BS. For example, referring again to FIG. 9A, transmission of PUSCH1 is interrupted by the end of the part 801a. In such case, the part 802a is vacant. The UE may then transmit PUSCH2 on the part 802a.

For external instruction, it may be due to second data transmission is to be transmitted from other devices. Moreover, the second is more urgent or has a higher priority than the first data transmission. In such, the BS or other device may request to terminate or interrupt the first data transmission between the current UE and the BS.

In an example, PUSCH1 and PUSCH2 are from different UEs (e.g., UE1 and UE2).

While UE1 is transmitting PUSCH1 to the BS, if PUSCH2 is more urgent than PUSCH1, UE2 may request to terminate or interrupt PUSCH1 between the UE1 and the BS. In such case, UE2 may interrupt UE1 from transmitting PUSCH1. For example, referring again to FIG. 9A, transmission of PUSCH1 is interrupted by the end of the part 801a. In such case, the part 802a is vacant. UE2 may then transmit PUSCH2 on the part 802a.

In an implementation, the condition may be a priority of the second data transmission is higher than a priority of the first data transmission.

In such case, the overlapped part of the first set of resources and the second set of resources may be used for the second data transmission instead of being used for the first data transmission. In some cases, the first data transmission which is of lower priority may be punctured by the second data transmission which is of higher priority.

The priority of the first data transmission and the priority of the second data transmission may be each indicated by a respective priority index. Alternatively, the priority of the first data transmission and the priority of the second data transmission may be each indicated by a respective priority ID.

The priority of the first data transmission may be based on at least one of: payload content of the first data transmission, a channel quality of a channel for transmitting the first data transmission, transmission mode for transmitting the first data transmission, bandwidth part for transmitting the first data transmission, antenna configuration for transmitting the first data transmission, device capability for transmitting the first data transmission.

Similarly, the priority of the second data transmission may be based on at least one of: a payload content of the second data transmission, a channel quality of a channel for transmitting the second data transmission, a transmission mode for transmitting the second data transmission, a bandwidth part for transmitting the second data transmission, an antenna configuration for transmitting the second data transmission, or a device capability for transmitting the second data transmission.

Additional description pertaining to the priority of the data transmission is provided above and therefore will not be repeated.

The UE may transmit a fourth indication for indicating a priority index of the first data transmission, a priority index of the second data transmission, or the priority index of the first data transmission and the priority index of the second data transmission.

In this way, after receiving the priority index of the first data transmission and the second data transmission respectively, the BS may know the respective priority of the first data transmission and the second data transmission. Moreover, as described above, since the overlapped part of the first set of resources and the second set of resources will be used for the data transmission with a higher priority, after receiving the fifth indication, the BS may determine which one of the first data transmission and the second data transmission will be transmitted over the overlapped part of the first set of resources and the second set of resources.

It will be appreciated that the first data transmission and the second data transmission may be from different UEs. In such case, the UE which is to transmit the first data transmission may transmit to the BS the indication for indicating a priority index of the first data transmission, and another UE which is to transmit the second data transmission may transmit to the BS the indication for indicating a priority index of the first data transmission.

The fourth indication may be carried in a control signal such as UCI, which is not limited in the present disclosure.

In an implementation, the condition may be a channel quality of a channel for transmitting the second data transmission is above a threshold.

In some cases, the proposed scheme is backward compatible, and the BS may enable the UE to adopt the proposed scheme by transmitting the first indication to the UE.

In some embodiments, in step 1300, the BS may transmit a first indication enabling receiving of the second data transmission on the second set of resources in the case where the condition is satisfied. Accordingly, the UE may receive the first indication. Step 1300 may be performed before step 1301, and it is optional.

In some cases, the UE may start to transmit the second data transmission after a pre-configured or agreed time gap.

In some embodiments, the BS may send a second indication indicating a first time gap between a receiving time of the notification and a start time at which the second data transmission is to be received. Accordingly, the UE may receive the third indication. In this way, the UE may determine the transmission time of the second data. This step is optional.

The first time gap may be related to UE processing capability, timing advance, and may be pre-configured in RRC, or indicated by DCI.

For example, referring again to FIG. 9C, resource 801 is for transmitting PUSCH1, and resource 802 is for transmitting PUSCH2. PUSCH1 and PUSCH2 are transmitted from the same UE. In addition, the third indication indicates that T1 is the time gap between the time at which the notification is received by the UE and the start time at which PUSCH2 is to be transmitted.

For example, PUSCH1 is successfully decoded at the end of the part 801a. The BS then transmits a notification indicating the successful decoding of PUSCH1 at the end of the part 801a which is the earliest feedback timing. In such case, the UE receives the notification at t1 and may start to transmit PUSCH2 at time t2, and t2=t1+T1. In this way, the UE may determine the time at which to transmit PUSCH2.

In some embodiments, the first data transmission and the second data transmission are transmitted by different UEs. The first data transmission may be transmitted by a first UE, and the second data transmission may be transmitted by a second UE.

As described above, the BS may transmit the notification indicating the stop (e.g., completion) of the first data transmission when the first data transmission is complete. In some cases, the second UE may monitor or listen for the notification transmitted from the BS to the first UE. Once detecting the notification indicating the completion of the first data transmission, the second UE may start to transmit the second data transmission.

In some embodiments, the second UE may start to transmit the second transmission after an agreed time gap.

In some embodiments, the BS may send to the second UE a third indication indicating a second time gap between a detection time of the notification and a start time at which the second data transmission is to be received. Accordingly, the second UE may receive the third indication. In this way, the UE may determine the transmission time of the second data transmission. This step is optional.

The second time gap may be based on UE processing capability, timing advance. The second time gap may be pre-configured in RRC, or indicated by DCI.

For example, referring again to FIG. 9D, resource 801 is for transmitting PUSCH1, and resource 802 is for transmitting PUSCH2. PUSCH1 is from UE1, and PUSCH2 is from UE2. In addition, the third indication indicates that T2 is the time gap between the time at which the notification indicating PUSCH1 is successfully decoded is detected and a start time at which the PUSCH2 is to be transmitted.

For example, PUSCH1 is successfully decoded at the end of the part 801a. The BS then transmits a notification indicating PUSCH1 is successfully decoded at an earliest feedback timing. Accordingly, UE2 may detect the notification at time t01. In such case, UE2 may start to transmit PUSCH2 at time t02, and t02=t01+T2. In this way, UE 2 may determine the time at which to transmit PUSCH2.

In some embodiments, in the case where the first data transmission and the second data transmission are from different UEs, a UE may detect for transmission from another UE.

For example, the first data transmission is from the first UE, and the second data transmission is from the second UE. Before transmitting the second data transmission, the second UE may detect for the first data transmission. And the second UE may transmit the second data transmission on the second set of resources in a case where it detects absence of the first data transmission.

The second UE may detect for the first data transmission by energy detection. In some cases, a UE that hopes to transmit the second data can receive but cannot decode other UE's transmissions. In this case, the UE may perform energy detection so that it may know whether a primary transmission is ongoing.

For example, the second UE may turn on the receiver and try to receive the potential signals on certain resources where the first UE may transmit its own signals. If the power or energy of the received signals from the first data transmission is above a threshold, then the second UE may know that the first UE is transmitting the first data transmission. In this way, the first data transmission is detected. Otherwise, the first data transmission is not detected, and the second UE may start to transmit the second data transmission.

In the proposed method for data transmission, overlapped resources are allocated to different data transmission, and the overlapped resources are conditionally scheduled. In conditional scheduling scheme, some conditions such as priority of different data transmissions are taken into consideration. In this way, flexibility of transmission is improved.

In an example, compared to contention-based transmission where first-come-first-serve scheme is adopted, in the present disclosure, the incumbent transmission may be punctured by another data transmission with high priority.

In another example, compared to pre-emotion transmission where the incumbent transmission is always punctured and resource allocated for the newly scheduled transmission is indicated after transmission, in the present disclosure, scheduling for different data transmissions are pre-configured and signaled in advance (e.g., before the transmission), and the incumbent transmission may not always be punctured (e.g., in the case where the incumbent transmission has a higher priority).

Some embodiments of the present disclosure provide a computer-readable storage medium (e.g., a non-transitory computer-readable storage medium). The computer-readable storage medium has stored thereon program instructions that, when run on a network device/terminal device, cause the network device/terminal device to execute one or more steps of the method for beam management as described in any one of the above embodiments.

For example, the computer-readable storage medium includes, but is not limited to, a magnetic storage device (e.g., a hard disk, a floppy disk or a magnetic tape), an optical disk (e.g., a compact disk (CD), or a DVD), a smart card, and a flash memory device (e.g., an erasable programmable read-only memory (EPROM), a card, a stick or a key driver). Various computer-readable storage media described in the embodiments of the present disclosure may represent one or more devices and/or other machine-readable storage media, which are used for storing information. The term “computer-readable storage medium” may include, but is not limited to, wireless channels and various other media capable of storing, containing and/or carrying instructions and/or data.

Some embodiments of the present disclosure further provide a computer program product. The computer program product includes program instructions carried on a non-transitory computer-readable storage medium. When executed on a network device/terminal device, the computer program instructions cause the network device/terminal device to perform one or more steps of the method for data transmission as described in the above embodiments.

Beneficial effects of the computer-readable storage medium and the computer program product are the same as the beneficial effects of the method for data transmission as described in some of the above embodiments, and details will not be repeated here.

The foregoing descriptions are merely specific implementations of the present disclosure, but the protection scope of the present disclosure is not limited thereto. Any changes or replacements within the technical scope of the present disclosure shall be included in the protection scope of the present disclosure. Therefore, the protection scope of the present disclosure shall be subject to the protection scope of the claims.

In some aspects of the present disclosure, there is provided a computer program comprising instructions. The instructions, when executed by a processor, may cause the processor to implement a method of the present disclosure.

In some aspects of the present disclosure, there is provided an integrated circuit. The integrated circuit includes one or more logic circuits for executing the steps of the method for data transmission of the present disclosure.

In some aspects of the present disclosure, there is provided an apparatus comprising means (e.g., at least one processor) to implement a method of the present disclosure. The apparatus may be device (that is, a terminal device or a network device) or a module or component in the device. The at least one processor may execute instructions stored in a computer-readable medium to implement the method.

The apparatus may be a communication device or an apparatus implemented in a communication device. For example, the apparatus implemented in a communication device may be an integrated circuit, which in some contexts may be known by other colloquial names, such as chip, modem, modem chip, baseband chip, or baseband processor. In some implementations, one or more integrated circuits can be packaged into a system-on-chip, a system-in-package, or a multi-chip module. The apparatus may comprise one or more integrated circuits or comprise one or more integrated circuits and other discrete components.

It will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device/apparatus or accessible or connectable thereto. Computer/processor readable/executable instructions to implement a method, an application or a module described herein may be stored or otherwise held by such non-transitory computer/processor readable storage media.

It could be noted that the message in the disclosure could be replaced with information, which may be carried in one single message, or be carried in more than one separate message.

The terms “apparatus” and “device” are used exchangeable.

In the disclosure, the word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

In the disclosure, the words “first”, “second”, etc., when used before a same term (e.g., UE, or an operating step) does not mean an order or a sequence of the term. For example, the “first UE” and the “second UE”, means two different UEs without specially indicated, and similarly, the “first step” and the “second step” means two different operating steps without specially indicated, but does not mean the first step have to happen before the second step. The real order depends on the logic of the two steps.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

The term “receive”, “detect” and “decode” as used herein can have several different meanings depending on the context in which these terms are used. For example, without special note, the term “receive” may indicate that information (e.g., DCI, or MAC-CE, RRC signaling or TB) is received successfully by the receiving node, which means the receiving side correctly detect and decode it. In this scenario, “receive” may cover “detect” and “decode” or may indicates same thing, e.g., “receive paging” means decoding paging correctly and obtaining the paging successfully, accordingly, “the receiving side does not receive paging” means the receiving side does not detect and/or decoding the paging. “paging is not received” means the receiving side tries to detect and/or decoding the paging, but not obtain the paging successfully. The term “receive” may sometimes indicate that a signal arrives at the receiving side, but does not mean the information in the signal is detected and decoded correctly, then the receiving side need perform detecting and decoding on the signal to obtain the information carried in the signal. In this scenario, “receive”, “detect” and “decode” may indicate different procedure at receiving side to obtain the information. Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. When combining two or more embodiments, not all the features in the embodiments to be combined are necessary for the combination.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

The following acronyms and abbreviations may be used in the present disclosure:

| | |
|---|---|
| | Acronym/Abbreviation/ |
| Full Name | Initialism |

Communication related

| | |
|---|---|
| Long Term Evolution | LTE |
| New Radio | NR |
| Forward error correction | FEC |
| Multiple Access | MA |
| Quality of Service | QoS |
| low-density parity check codes | LDPC |
| cyclic redundancy check | CRC |
| ultra-reliable low latency communications | uRLLC |
| Enhanced mobile broadband | eMBB |
| massive Machine Type Communications | mMTC |
| non-terrestrial networks | NTN |
| Internet of Things | IoT |
| Bit Error Rate | BER |
| Block Error Rate | BLER |
| Packet Error Rate | PER |
| Spectral Efficiency | SE |
| Hybrid automatic repeat request | HARQ |
| Channel Quality Indicator | CQI |
| Modulation Coding Scheme | MCS |
| gNodeB or 5G base station | gNB |
| user equipment | UE |
| Radio Resource Control | RRC |
| Radio Network Temporary Identifier | RNTI |
| Uplink Control Information | UCI |
| Downlink Control Information | DCI |
| Physical Broadcast Channel | PBCH |
| Half-radio frame bit | HRF |
| Synchronization Signal Block | SSB |
| unequal error protection | UEP |
| variable node | VN |
| check node | CN |
| Log-likelihood ratio | LLR |
| Successive cancellation | SC |
| Successive cancellation list | SCL |
| Belief propagation | BP |

1. A method, comprising:
transmitting information indicating a first set of resources for transmitting a first data transmission and a second set of resources for transmitting a second data transmission, wherein the first set of resources and the second set of resources are at least partially overlapped;
transmitting the first data transmission on the first set of resources; and
transmitting the second data transmission on the second set of resources in response to determining that a condition is satisfied, wherein the condition includes at least one of:
detecting a first signal indicating the second data transmission is to be transmitted on the second set of resources;
detecting a second signal indicating the first data transmission is stopped;
receiving a feedback indicating the first data transmission is successfully decoded;
a priority of the second data transmission is higher than a priority of the first data transmission; or
a channel quality of a channel for transmitting the second data transmission is above a threshold.

2. The method of claim 1, further comprising:
transmitting a first indication enabling receiving of the second data transmission on the second set of resources in response to determining that the condition is satisfied.

3. The method of claim 1, further comprising:
transmitting a third signal indicating the second data transmission is to be transmitted on the second set of resources or the second data transmission is being transmitted on the second set of resources.

4. The method of claim 3, wherein the transmitting the third signal comprises:
transmitting the third signal in response to determining that the condition is satisfied.

5. The method of claim 1, further comprising:
transmitting a third signal on a first N time domain resources of the second set of resources, wherein N is a positive integer.

6. The method of claim 1, further comprising:
transmitting a fifth indication indicating at least one of a priority index of the first data transmission or a priority index of the second data transmission.

7. A method, comprising:
receiving information indicating a first set of resources for receiving a first data transmission and a second set of resources for receiving a second data transmission, wherein the first set of resources and the second set of resources are at least partially overlapped;
receiving the first data transmission on the first set of resources; and
receiving the second data transmission on the second set of resources in response to determining that a condition is satisfied, wherein the condition includes at least one of:
detecting a third signal indicating the second data transmission is to be transmitted on the second set of resources or the second data transmission is being transmitted on the second set of resources;
the first data transmission is successfully decoded;
the first data transmission is stopped;
a priority of the second data transmission is higher than a priority of the first data transmission; or
a channel quality of a channel for transmitting the second data transmission is above a threshold.

8. The method of claim 7, further comprising:
receiving a first indication enabling receiving of the second data transmission on the second set of resources in response to determining that the condition is satisfied.

9. The method of claim 7, further comprising:
transmitting a first signal indicating the second data transmission is to be received on the second set of resources;
transmitting a second signal indicating the first data transmission is stopped; or
transmitting a feedback indicating the first data transmission is successfully decoded.

10. The method of claim 7, further comprising:
receiving the third signal on a first N time domain resources of the second set of resources, wherein N is a positive integer.

11. An apparatus, comprising:
at least one processor; and
at least one memory coupled to the at least one processor, the at least one memory storing at least part of instructions that, when executed by the at least one processor, cause the at least one processor to:
transmit information indicating a first set of resources for transmitting a first data transmission and a second set of resources for transmitting a second data transmission, wherein the first set of resources and the second set of resources are at least partially overlapped;
transmit the first data transmission on the first set of resources; and
transmit the second data transmission on the second set of resources in response to determining that a condition is satisfied, wherein the condition includes at least one of:
detecting a first signal indicating the second data transmission is to be transmitted on the second set of resources;
detecting a second signal indicating the first data transmission is stopped;
receiving a feedback indicating the first data transmission is successfully decoded;
a priority of the second data transmission is higher than a priority of the first data transmission; or
a channel quality of a channel for transmitting the second data transmission is above a threshold.

12. The apparatus of claim 11, wherein the at least part of the instructions further cause the apparatus to:
transmit a first indication enabling receiving of the second data transmission on the second set of resources in response to determining that the condition is satisfied.

13. The apparatus of claim 11, wherein the at least part of the instructions further cause the apparatus to:
transmit a third signal indicating the second data transmission is to be transmitted on the second set of resources or the second data transmission is being transmitted on the second set of resources.

14. The apparatus of claim 13, wherein the at least part of the instructions cause the apparatus to transmit the third signal by:
transmitting the third signal in response to determining that the condition is satisfied.

15. The apparatus of claim 11, wherein the at least part of the instructions further cause the apparatus to:
transmit a third signal on a first N time domain resources of the second set of resources, wherein N is a positive integer.

16. The apparatus of claim 11, wherein the at least part of the instructions further cause the apparatus to:
transmit a fifth indication indicating at least one of a priority index of the first data transmission or a priority index of the second data transmission.

17. An apparatus, comprising:
at least one processor; and
at least one memory coupled to the at least one processor, the at least one memory storing at least part of instructions that, when executed by the at least one processor, cause the at least one processor to:
receive information indicating a first set of resources for receiving a first data transmission and a second set of resources for receiving a second data transmission, wherein the first set of resources and the second set of resources are at least partially overlapped;
receive the first data transmission on the first set of resources; and
receive the second data transmission on the second set of resources in response to determining that a condition is satisfied, wherein the condition includes at least one of:
detecting a third signal indicating the second data transmission is to be transmitted on the second set of resources or the second data transmission is being transmitted on the second set of resources;
the first data transmission is successfully decoded;
the first data transmission is stopped;
a priority of the second data transmission is higher than a priority of the first data transmission; or
a channel quality of a channel for transmitting the second data transmission is above a threshold.

18. The apparatus of claim 17, wherein the at least part of the instructions further cause the apparatus to:
receive a first indication enabling receiving of the second data transmission on the second set of resources in response to determining that the condition is satisfied.

19. The apparatus of claim 17, wherein the at least part of the instructions further cause the apparatus to:
transmit a first signal indicating the second data transmission is to be received on the second set of resources;
transmit a second signal indicating the first data transmission is stopped; or
transmit a feedback indicating the first data transmission is successfully decoded.

20. The apparatus of claim 17, wherein the at least part of the instructions further cause the apparatus to:
receive the third signal on a first N time domain resources of the second set of resources, wherein N is a positive integer.
